(19) United States
(12) Patent Application Publication
(10) Pub. No.: US 2024/0411547 A1
(43) Pub. Date: Dec. 12, 2024

(54) A CONCEPT FOR CONTROLLING AN UPDATE PROCESS OF A COMPUTATIONAL FUNCTION BLOCK IN A VEHICLE

(71) Applicant: Volkswagen Aktiengesellschaft, Wolfsburg (DE)

(72) Inventor: Stephan MAX, Wolfsburg (DE)

(21) Appl. No.: 18/698,736

(22) PCT Filed: Oct. 5, 2021
(86) PCT No.: PCT/EP2021/077340

§ 371 Date: Apr. 4, 2024

(51) Int. Cl. G06F 8/65

(52) U.S. Cl. CPC G06F 8/65

(57) ABSTRACT

Various aspects relate to an apparatus, a method, and a computer program for controlling an update process of a computational function block in a vehicle, to a computational function block and a corresponding method and computer program, and to a corresponding vehicle. The apparatus for controlling an update process of a computational function block in a vehicle comprises at least one interface for communicating with the computational function block. The apparatus comprises one or more processors, configured to determine information on a preparedness of the computational function block for updating the computational function block. The information on the preparedness indicates the individual preparedness of the computational function block. The one or more processors are configured to trigger an update of the computational function block if the information on the preparedness indicates that the computational function block is ready to be updated.

### BACKGROUND

### Technical Field

A Concept for Controlling an Update Process of a Computational Function Block in a Vehicle

### Description of the Related Art

The present disclosure relates to an apparatus, a method, and a computer-readable medium storing a computer program that controls an update process of a computational function block in a vehicle, to a computational function block and a corresponding method and computer-readable medium storing a computer program, and to a corresponding vehicle.

In modern vehicles, an ever-increasing number of functions are provided by software. These functions are usually implemented by services that run on the vehicle's computation devices. In general, such functions can be implemented within function containers, also denoted computational function blocks, which can be executed within a runtime environment being provided by a computation device of the vehicle. In particular, the so-called “automotive edge” consists of, or is implemented using, function containers. For example, the automotive edge may function as a base platform for all online services of a vehicle.

Since such function containers are software-based, there is a desire to update them frequently. In vehicles, such an update of the function containers can be performed by a container update software being part of the system software of the vehicle. In many implementations, the update is only performed when the car stands still or is switched off. To trigger the update, thereby setting the time the function containers are update, a generic ready-for-update evaluation is performed by the container update software, e.g., based on signals of the car indicating that the car is switched off or stands still (e.g., by checking registers for simple conditions like “motor off=true,” “parking brake active=true,” etc.). In many cases, this may delay updates, as the updates can only be performed when the generic conditions are met, e.g., while the car is inactive or even after a pre-defined time of inactivity.

US patent application US 2017/0262277 A1 relates to a software management system for a vehicle. While updates to vehicular software are generally discussed, the disclosure is silent on the determination of a timing of such updates. Moreover, the updates, and therefore also the timing of the updates, is based on a permission given by a user of the vehicle.

International patent application W02015/0154636 A1 also relates to vehicular software updates. US patent application US 2011/0225416 A1 relates to an update of a configuration of vehicular software. However, both disclosures are also silent on the determination of a timing of such updates.

There may be a desire for an improved concept for updating vehicular software. This desire is addressed by the subject-matter of the independent claims.

Embodiments are based on the finding that, even while vehicles are in use, a large number of software functions are not currently in use and can therefore be updated even during use of the vehicle. On the other hand, some software functions are in use even while the vehicle is switched off, e.g., to control a charging functionality, or to keep contact with a backend server. Therefore, there is no single point in time that is suitable for updating all of the software of the vehicle. The present disclosure therefore provides a concept for determining, individually for each function container/computational function blocks, whether the computational function blocks is prepared (i.e., “ready”) to be updated, and for triggering the update at a suitable time.

### BRIEF SUMMARY

An aspect of the present disclosure relates to an apparatus for controlling an update process of a computational function block in a vehicle. The apparatus comprises at least one interface for communicating with the computational function block. The apparatus comprises one or more processors, configured to determine information on a preparedness of the computational function block for updating the computational function block. The information on the preparedness indicates the individual preparedness of the computational function block. The one or more processors are configured to trigger an update of the computational function block if the information on the preparedness indicates that the computational function block is ready to be updated. By determining the individual preparedness of the computational function block to be updated, various computational function blocks of the vehicle can be updated at suitable times, without having to wait for the vehicle to be switched off.

There are two general approaches to determining the individual preparedness—to request the computational function block to indicate its preparedness for updating, or to use a ruleset comprising rules for determining the preparedness of the computational function block based on the state of the vehicle and based on the state of the computational function block.

Accordingly, the one or more processors may be configured to obtain, from the computational function block, the information on the preparedness of the computational function block for updating the computational function block. In other words, the (or each) computational function block may comprise functionality to determine its preparedness for updating, depending on the state of the computational function block, the functions currently being performed (or not), etc.

This approach may be scaled to cover various computational function blocks of the vehicle. For example, the apparatus may be suitable for controlling the update process of a plurality of computational function blocks of the vehicle. Accordingly, the one or more processors may be configured to determine information on a preparedness of the plurality of computational function blocks for updating the plurality of computational function blocks by obtaining the information on the preparedness of the plurality of computational function block individually from each of the plurality of computational function blocks. The one or more processors may be configured to trigger the update of the respective computational function blocks if the information on the preparedness indicates that the respective computational function blocks are ready to be updated. By treating each computational function block individually, each of the computational function blocks can be updated at a suitable time, without having to wait for a time when all of the computational function blocks are ready to be updated.

In general, the computational function block or the plurality of computational function blocks may signal their preparedness for updating. Therefore, the one or more processors can obtain the information on the preparedness (directly) from the computational function block(s).

Again, two general mechanisms are possible. In a first mechanism, the one or more processors may be configured to read out a flag comprising the information on the preparedness from the computational function block or from the individual computational function blocks. This may require the computational function block to expose this feature, e.g., from a register provided by the computational function block(s). For example, when this flag is set, the computational function block might not have to be started or woken up if the computational function block is in a sleep state or shutdown state.

Alternatively, the information on the preparedness may be actively requested from the computational function block. The one or more processors may be configured to request the information on the preparedness from the computational function block or from the individual computational function blocks, and to receive the information on the preparedness from the computational function block or from the individual computational function blocks in response to the request. In this case, the computational function blocks might not be required to expose flags, so the functionality can be provided without changing the overall capabilities of the engine being used to create and run the computational function blocks.

As outlined above, the individual preparedness may also be determined using a computational function block-specific ruleset. The one or more processors may be configured to determine the information on the preparedness based on a ruleset for determining the preparedness of computational function blocks depending on a state of the computational function block and on a state of the vehicle. The ruleset may comprise rules for determining the preparedness of computational function blocks for updating on a per-computational function block basis. This may enable determining the individual preparedness of computational function blocks without modifying the functionality of the respective computational function blocks.

For example, the computational function block may originate from a software repository. The one or more processors may be configured to obtain the ruleset for determining the preparedness of the computational function blocks from the software repository. In other words, the ruleset may be obtained together with the respective computational function block.

In some examples, the apparatus is suitable for controlling the update process of a plurality of computational function blocks of the vehicle. The one or more processors may be configured to determine information on a preparedness of the plurality of computational function blocks for updating the plurality of computational function blocks by determining the preparedness of each computational function block individually using the ruleset. The one or more processors may be configured to trigger the update of the respective computational function blocks if the information on the preparedness indicates that the respective computational function blocks are ready to be updated. By treating each computational function block individually, each of the computational function blocks can be updated at a suitable time, without having to wait for a time when all of the computational function blocks are ready to be updated.

In some cases, computational function blocks may malfunction. In this case, they might not be able to provide the information on the preparedness of the computational function block, or their state being used to determine the information on the preparedness of the computational function block may be incorrect. The one or more processors may be configured to override the information on the preparedness of the computation function block if the computation function block is deemed to be unresponsive. This may avoid situations in which a computational function block is not updated due to its unresponsiveness/malfunction.

A further aspect relates to a vehicle comprising the apparatus for controlling the update process of a computational function block or of a plurality of computational function blocks of the vehicle.

As outlined above, in some examples, the respective computational function blocks may be configured to provide the information on the preparedness of the computational function block for updating. Accordingly, an aspect of the present disclosure relates to a computational function block for a vehicle. The computational function block comprises at least one interface for communicating with an apparatus for controlling an update process of a computational function block. The computational function block comprises a processing functionality configured to determine a preparedness of the computational function block for updating the computational function block. The processing functionality is configured to provide information on the preparedness of the computational function block for updating to the apparatus for controlling the update process. This way, each computational function block may indicate its preparedness for updating to the apparatus for controlling the update process.

In some examples, the processing functionality is configured to expose the information on the preparedness as a flag to the apparatus for controlling the update. For example, when this flag is set, the computational function block might not have to be started or woken up if the computational function block is in a sleep state or shutdown state.

Alternatively, the processing functionality may be configured to obtain a request for the information on the preparedness from the apparatus for controlling the update process, and to provide the information on the preparedness to the apparatus for controlling the update process in response to the request. In this case, the computational function blocks might not be required to expose flags, so the functionality can be provided without changing the overall capabilities of the engine being used to create and run the computational function blocks.

A further aspect relates to a vehicle comprising the apparatus for controlling the update process of a computational function block or of a plurality of computational function blocks of the vehicle, the vehicle further comprising the computational function block or the plurality of computational function blocks.

A further aspect of the present disclosure relates to a corresponding method for controlling an update process of a computational function block in a vehicle. The method comprises determining information on a preparedness of the computational function block for updating the computational function block. The information on the preparedness indicates the individual preparedness of the computational function block. The method comprises triggering an update of the computational function block if the information on the preparedness indicates that the computational function block is ready to be updated.

A further aspect of the present disclosure relates to a corresponding method for a computational function block for a vehicle, with the computational function block performing the method. The method comprises determining a preparedness of the computational function block for updating the computational function block. The method comprises providing information on the preparedness of the computational function block for updating.

A further aspect of the present disclosure relates to a corresponding computer program having a program code for performing one of the above methods, when the computer program is executed on a computer, a processor, or a programmable hardware component.

### BRIEF DESCRIPTION OF THE SEVERAL VIEWS OF THE DRAWINGS

Some examples of apparatuses and/or methods will be described in the following by way of example only, and with reference to the accompanying figures, in which:

FIG. 1a shows a block diagram of an example of an apparatus for controlling an update process of a computational function block in a vehicle;

FIG. 1b shows a schematic diagram of an example of a vehicle comprising an apparatus for controlling an update process of a computational function block and a computational function block;

FIG. 1c shows a flow chart of an example of a method for controlling an update process of a computational function block;

FIG. 2a shows a block diagram of an example of a computational function block and of a computation device being configured to execute the computational function block;

FIG. 2b shows a flow chart of an example of a method for a computational function block; and

FIG. 3 shows a schematic diagram of three different approaches for updating a computational function block.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an ‘or,’ this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a,” “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include,” “including,” “comprise” and/or “comprising,” when used, describe the presence of the specified features, integers, steps, operations, processes, elements, components and/or a group thereof, but do not exclude the presence or addition of one or more other features, integers, steps, operations, processes, elements, components and/or a group thereof.

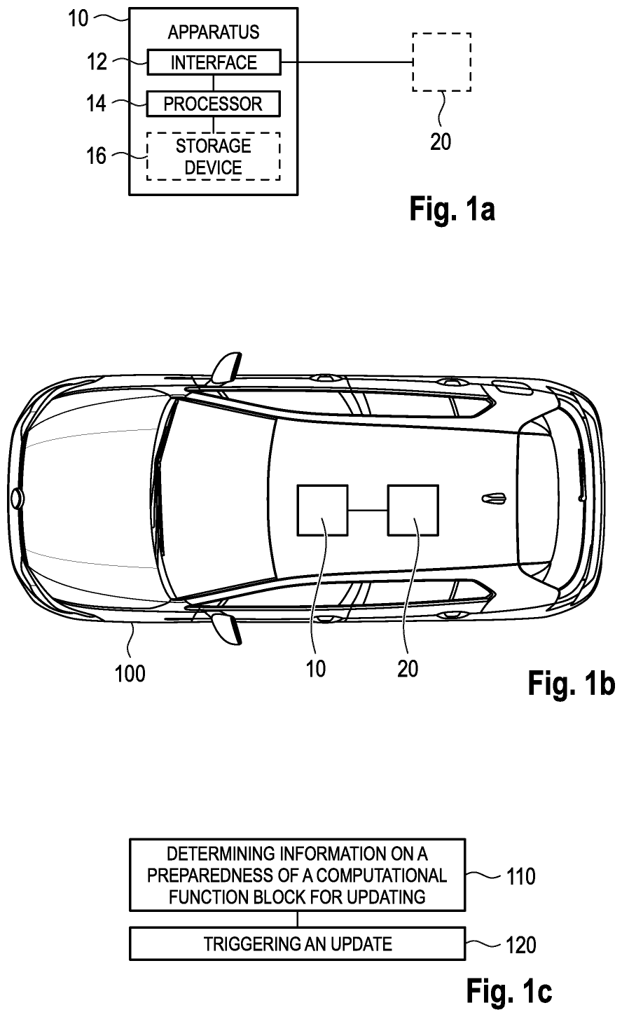

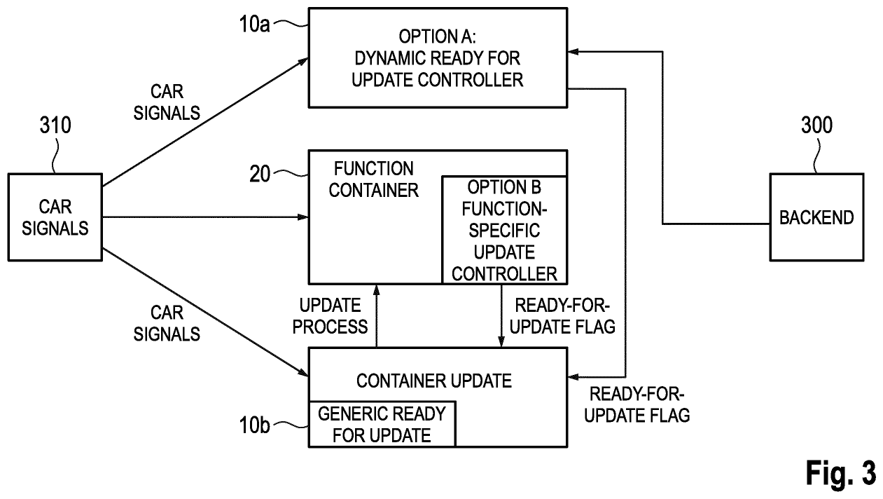

FIG. 1a shows a block diagram of an example of an apparatus 10 for controlling an update process of a computational function block 20 in a vehicle 100 (shown in FIG. 1b). The apparatus 10 comprises at least one interface 12 for communicating with the computational function block 20. The apparatus 10 comprises one or more processors 14. Optionally, the apparatus 10 further comprises one or more storage devices 16. The one or more processors 14 are coupled with the at least one interface 12 and the optional one or more storage devices 16. In general, the functionality of the apparatus 10 is provided by the one or more processors 14, in conjunction with the at least one interface 12 (for exchanging information, e.g., with the computational function block 20 or with a backend server/software repository 300, as shown in FIG. 3), and in conjunction with the optional one or more storage devices 16 (e.g., for storing and/or retrieving information).

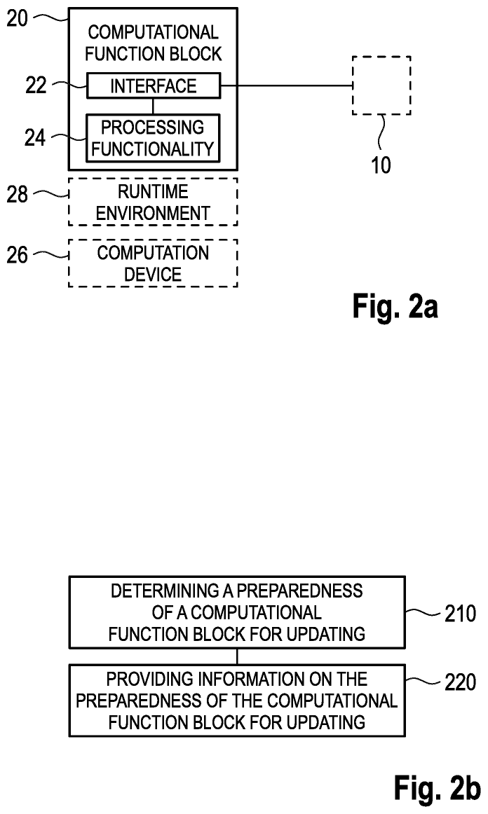

The one or more processors 14 are configured to determine information on a preparedness of the computational function block for updating the computational function block. The information on the preparedness indicates the individual preparedness of the computational function block. The one or more processors 14 are configured to trigger an update of the computational function block if the information on the preparedness indicates that the computational function block is ready to be updated. For example, the apparatus 10 may be part of the vehicle 100, as shown in the following figures. As will be outlined in more detail in connection with FIG. 2a, the apparatus 10 may be further configured to provide a runtime environment for the computational function block. Alternatively, the vehicle may comprise a separate computation device being configured to execute the computational function block (e.g., within a runtime environment).

FIG. 1b shows a schematic diagram of an example of the vehicle 100 comprising the apparatus 10 for controlling the update process of the computational function block and the computational function block 20. In some examples, the vehicle may comprise a separate computation device being configured to execute the computational function block.

Moreover, the vehicle may comprise a plurality of computational function blocks, which may be executed by the apparatus 10 or by one or more separate computation devices. Accordingly, the apparatus may be suitable for controlling the update process of a plurality of computational function blocks 30 of the vehicle.

FIG. 1c shows a flow chart of an example of a corresponding method for controlling the update process of a computational function block. The method comprises determining 110 the information on the preparedness of the computational function block for updating the computational function block. The method comprises triggering 120 the update of the computational function block if the information on the preparedness indicates that the computational function block is ready to be updated. For example, the method may be performed by the vehicle, e.g., by the apparatus 10 introduced in connection with FIGS. 1a and/or 1b.

In the following, the proposed concept is introduced with respect to the apparatus 10 of FIGS. 1a and/or 1b. Features introduced in connection with the apparatus may likewise be included in the corresponding method of FIG. 1c and/or in the corresponding computer program.

The present disclosure relates to a concept for controlling an update process of computational function blocks in a vehicle. In short, the proposed concept may be used to determine, whether the computational function blocks of the vehicle are ready for container update.

As outlined above, in vehicles, functionality is increasingly being provided by software. This software may be provided as so-called software containers, which are denoted computational function blocks in the present disclosure. One or more services can be encapsulated with all their dependencies in such a computational function block/software container. Software containers are particularly known for use on servers and developer devices. For example, such containers may be provided by various container engines (Docker, Podman, Crio, . . . ). In the present disclosure, such software containers are adapted for the use in vehicles.

In general, each computational function block represents a vehicle functionality that is implemented by software. In other words, each computational function block is configured to provide a vehicle functionality of the vehicle. In particular, each computational function block represents a software-implemented vehicle functionality. Also, each computational function block is encapsulated, i.e., it includes all program code and dependencies, to be executable within a runtime environment of a computation device, such as the computation device 26 of FIG. 2a or the apparatus 10. Abstract interfaces may be provided, by the respective computation device, to access sensors/actuators, communication channels and host resources from within the runtime environment. For this purpose, the computational function blocks can be implemented, for example, as software containers that are used in runtime environments that provide standardized and abstracted interfaces for the containers. Accordingly, each computational function block may be designed to be executed as a container within a runtime environment. In turn the computation device may be configured to provide a runtime environment for the execution of containers.

The present disclosure relates to updates to such computational function blocks. In general, since the computational function blocks are software-based, each computational function block can be updated using mechanisms used in other software fields. For example, when a computational function block is updated the program code within the computational function blocks can be updated, or the entire computational function block may be replaced with an updated version of the computational function block. However, since the computational function block is being used in a vehicle, there are restrictions regarding updates to computational function blocks. For example, some computational function blocks, e.g., computational function blocks being configured to provide safety-critical functionality during operation of the vehicle, might only be updateable when the vehicle is switched off, while other computational function blocks, such as a computational function block being configured to provide navigational functionality or a computational function block being configured to provide a media functionality can be updated during operation of the vehicle while they are not actively being used. Other computational function blocks, e.g., computational function block being active during a charging procedure of the vehicle, might only be updated when the vehicle is not being charged. As is evident, there is little or no time that is suitable for updating all computational function blocks. In other concepts, the update occurs when such a point in time is reached (e.g., when the vehicle is switched off and is not being charged). However, this may delay the application of updates. Moreover, it may be beneficial to have access to a mobile communication system during the update, which may not be the case if the vehicle is parked in a parking garage. Therefore, it may be beneficial to be more flexible regarding the time the updates are being applied. The proposed concept therefore seeks to determine individually for each of the computational function blocks being used in a vehicle whether they are presently updatable, so the respective computational function blocks can be updated in a timely manner, at a suitable time.

Accordingly, the one or more processors are configured to determine the information on the preparedness of the computational function block for updating the computational function block, with the information on the preparedness indicating the individual preparedness of the computational function block. In contrast to other systems, the proposed concept attempts to determine the time for triggering the update one a per-computational function block level, by generating the information on the preparedness such that it indicates the individual preparedness of the computational function block.

Two general approaches may be chosen when determining the preparedness of the computational function block or computational function block—either the computational function blocks determine their preparedness for updating themselves, or the apparatus 10 uses a ruleset that enables it to determine the preparedness of the individual computational function block(s).

In the following, the first approach is introduced. Accordingly, the one or more processors may be configured to obtain, from the computational function block, the information on the preparedness of the computational function block for updating the computational function block. In other words, determining the information on the preparedness may comprise, or correspond to, receiving or reading out the information on the preparedness from the computational function block(s) in question. This approach can be chosen when the apparatus is tasked with determining the preparedness of a single computational function block as well as when the apparatus is tasked with determining the preparedness of a plurality of computational function blocks of the vehicle. Accordingly, the one or more processors may be configured to determine information on a preparedness of the plurality of computational function blocks for updating the plurality of computational function blocks by obtaining the information on the preparedness of the plurality of computational function block individually (i.e., separately) from each of the plurality of computational function blocks. The approach is the same—the respective information on the preparedness may be read out or received separately from each of the computational function block.

As outlined above, there are two general mechanisms for obtaining the information on the preparedness from the computational function block(s). As a prerequisite, the respective information on the preparedness may be provided, i.e., signaled by the respective computational function block(s). In other words, the computational function block or the plurality of computational function blocks signal their preparedness for updating.

In a first mechanism, the one or more processors may be configured to read out a flag comprising the information on the preparedness from the computational function block or from the individual computational function blocks. For example, the flag may be provided via a status register of the computational function block. The flag may be provided regardless of the state of the respective computational function block. For example, the flag may be read out while the computational function block is in a “sleep” or “shutdown” state. For example, the flag may be a binary flag, either indicating that the computational function block is ready (i.e., prepared) to be updated or that the computational function block is not ready to be updated.

In a second mechanism, the apparatus may exchange messages with the computational function block, e.g., via an application programming interface (API) or remote process call (RPC) or via an inter-process messaging interface. For example, the one or more processors may be configured to request the information on the preparedness from the computational function block or from the individual computational function blocks (e.g., via the API, via RPC or via the inter-process messaging interface), and to receive the information on the preparedness from the computational function block or from the individual computational function blocks in response to the request (e.g., via the API, via RPC or via the inter-process messaging interface).

In the second approach, the apparatus 10 is tasked with determining the information on the preparedness for the computational function block or computational function block(s). For example, the one or more processors may be configured to determine the information on the preparedness based on a ruleset for determining the preparedness of computational function blocks depending on a state of the computational function block and on a state of the vehicle. For example, the ruleset comprises rules for determining the preparedness of computational function blocks for updating on a per-computational function block basis. For example, the state of the computational function block may be one of “running,” “running/idle with information being displayed,” “running/idle without information being displayed,” “idle,” “shutdown,” “deactivated,” etc. The state of the vehicle may be one of “driving autonomously,” “driving semi-autonomously,” “driving manually,” “halting,” “parking,” “switched off,” “charging,” etc. Depending on the combination of states of the vehicle and the computational function block, the computational function block may be deemed to be ready to be updated. For example, a computational function block that is “idle without information being displayed,” “idle,” “shutdown,” “deactivated” may be deemed ready to be updated regardless of the state of the vehicle. If the state of the vehicle is “parking” or “switched off,” but the state of the computational function block is “idle with information being displayed” (e.g., in a status display), the computational function block may still be deemed to be ready to be updated. If the state of the vehicle is “charging,” any computational function block except those related to the charging may be deemed to be ready to be updated. If the state of the vehicle is “driving semi-autonomously,” any computational function block related to “driving autonomously” may be deemed not ready to be updated, etc. The ruleset may reflect the different combinations of state of the vehicle and state of the computational function block for each of the computational function blocks. For example, the computational function block(s) may be configured to expose its/their state, e.g., via a flag of the computational function block(s). The one or more processors may be configured to obtain information on the state of the vehicle from the vehicle, e.g., from car sensors 310 as shown in FIG. 3, and to obtain information on the state of the computational function block(s) from the respective computational function block(s).

Similar to the first approach, the second approach may be applied to multiple computational function blocks. Accordingly, the one or more processors may be configured to determine information on a preparedness of the plurality of computational function blocks for updating the plurality of computational function blocks by determining the preparedness of each computational function block individually using the ruleset.

In general, different types of software may be used in a vehicle, with some software being provided by the vehicle manufacturer, and with some software being provided by a third party, e.g., via a software repository (i.e., an “application store”) being operated by the vehicle manufacturer. Accordingly, the computational function block may originate from a software repository 300 (as shown in FIG. 3 as part of the backend 300). In such mixed environments, at least a portion of the ruleset being used may be provided together with the computational function block from the software repository (e.g., for software being provided by a third party). Accordingly, the one or more processors may be configured to obtain the ruleset for determining the preparedness of the computational function blocks from the software repository.

The one or more processors are configured to trigger the update of the computational function block, of the respective computational function blocks, if the information on the preparedness indicates that the computational function block or the respective computational function blocks is/are ready to be updated. In this context, the term “ready to be updated” means that the computational function block can be momentarily updated without loss of data. In other words, if a computational function block is ready to be updated, it is prepared for updating.

As outlined above, one of the benefits of the present disclosure may be to provide an approach for improving the timing of the individual updates of the computational function blocks.

Therefore, the one or more processors may be configured to determine a timing of the update of the computational function block(s) based on the information on the preparedness of the computational function block(s), and to trigger the update(s) according to the timing. For example, the one or more processors may be configured to schedule the update(s) according to the timing. For example, the one or more processors may be configured to trigger the update when the information on the preparedness indicates that the computational function block or the respective computational function blocks is/are ready to be updated, e.g., as soon as the information on the preparedness indicates that the computational function block or the respective computational function blocks is/are ready to be updated and/or in response to the information on the preparedness indicating that the computational function block or the respective computational function blocks is/are ready to be updated.

In some cases, computational function blocks may malfunction and/or be unresponsive. In this case, the information on the preparedness may be ignored, and the computational function blocks may be updated regardless. In other words, the one or more processors may be configured to override the information on the preparedness of the computation function block if the computation function block is deemed to be malfunctioning/unresponsive.

The mechanism introduced in the present disclosure is based on the use of software containers in vehicles. Examples may be compliant, for example, with the Open Container Initiative (OCI) runtime specification and/or image specification. In particular, various aspects of the present disclosure may be implemented according to, or building upon, the OCI runtime specification. In particular, the runtime commands may be used to tear down and initiate the respective containers in the runtime environment before and after updating the respective computational function block. Moreover, the image specification may be used or adapted to expose the flag comprising the information on the preparedness of the container for updating. In particular, the image specification may be extended to provide such a flag.

Examples may also be compliant with ECE/TRANS/WP.29, a United Nations regulation on uniform provisions concerning the approval of vehicles with regards to software update and software updates management systems. In particular, the examples may be compliant with section 7 of said regulation, and may implement or extend various sections, and in particular sections 7.2.2.1.3, 7.2.2.2.3 and 7.2.2.2.5. Examples may also be compliant with and/or implement and extend ISO/IEC 30165.

Examples may also be used to implement security relevant container updates for industrial applications.

The at least one interface 12 may correspond to one or more inputs and/or outputs for receiving and/or transmitting information, which may be in digital (bit) values according to a specified code, within a module, between modules or between modules of different entities. For example, the at least one interface 12 may comprise interface circuitry configured to receive and/or transmit information.

The one or more processors 14 may be implemented using one or more processing units, one or more processing devices, any means for processing, such as a processor, a computer or a programmable hardware component being operable with accordingly adapted software. In other words, the described function of the one or more processors 14 may as well be implemented in software, which is then executed on one or more programmable hardware components. Such hardware components may comprise a general purpose processor, a Digital Signal Processor (DSP), a micro-controller, etc.

In at least some embodiments, the one or more storage devices may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus, method, and computer program for controlling an update process of a computational function block in a vehicle are mentioned in connection with the proposed concept or one or more examples described above or below (e.g., FIG. 2a to 3).

The apparatus, method, and computer program for controlling an update process of a computational function block in a vehicle may comprise one or more additional optional features corresponding to one or more aspects of the proposed concept or one or more examples described above or below.

FIG. 2a shows a block diagram of an example of a computational function block 20 and of a computation device 26 being configured to execute the computational function block. The computational function block comprises at least one interface 22 for communicating with an apparatus 10 for controlling an update process of the computational function block 20. The computational function block comprises a processing functionality 24 configured to determine a preparedness of the computational function block for updating the computational function block. The processing functionality is configured to provide information on the preparedness of the computational function block for updating to the apparatus for controlling the update process.

FIG. 2a further shows a system comprising the computational function block 20 and the apparatus 10.

FIG. 2b shows a flow chart of an example of a corresponding method for a computational function block. The method is performed by the computational function block, e.g., the computational function block of FIG. 2a. The method comprises determining 210 the preparedness of the computational function block for updating the computational function block. The method comprises providing 220 the information on the preparedness of the computational function block for updating (e.g., to the apparatus 10 for controlling the update process of FIGS. 1a and/or 1b).

In the following, the functionality of the computational function block is elaborated with respect to the computational function block of FIG. 2a. Features of the computational function block 20 of FIG. 2 may likewise be applied to the corresponding method of FIG. 2b, and to the corresponding computer program.

Various properties of the computational function block 20 have already been introduced in connection with FIGS. 1a to 1c. In the following, the features related to the determination and provision of the information on the preparedness of the computational function block for updating are introduced in more detail.

As has been outlined in connection with FIGS. 1a to 1c, there are two general mechanisms for providing the information on the preparedness for the apparatus 10 of FIG. 1a. In a first mechanism, the processing functionality is configured to expose the information on the preparedness as a flag to the apparatus for controlling the update. In a second mechanism, the processing functionality is configured to obtain (e.g., receive) a request for the information on the preparedness from the apparatus for controlling the update process, and to provide (e.g., transmit) the information on the preparedness to the apparatus for controlling the update process in response to the request. For example, the request may be received and the response may be provided via one of an API, RPC or an inter-process messaging interface.

These two different mechanisms lead to two different mechanisms for determining the preparedness of the computational function block for updating.

In case the information on the preparedness is provided as a flag, the information on the preparedness is known at all times, and the computational function block, e.g., the processing functionality, may be configured to continuously (or periodically) update the flag. Therefore, the processing functionality may be configured to continuously or periodically determine the preparedness of the computational function block for updating. Upon detection of a change in the preparedness, the flag may be updated. For example, the flag may be set or updated by writing the content of the flag to a memory or register of the computational function block that is accessible to the computational function block.

In case the information on the preparedness is provided upon request of the apparatus 10, a different scenario emerges. In this case, the preparedness need only be known when the information on the preparedness is requested by the apparatus 10. Therefore, the processing functionality may be configured to determine the preparedness of the functional block in response to the request for the information on the preparedness. In some examples, the processing functionality may further be configured to transition the computational function block into a state where the computational function block is ready to be updated in response to the request for the information on the preparedness, and to provide the response once the computational function block is ready to be updated.

In general, the preparedness of the computational function block may be determined using two general approaches. In a first, coarse approach, the preparedness of the computational function block for updating may (solely) depend on whether the computational function block comprises information that is yet to be written to non-volatile memory or a storage device. In other words, the preparedness of the computational function block may depend on whether a momentary update of the computational function block would lead to data loss. If this is the case, i.e., if information is yet to be written to non-volatile memory/a momentary update would lead to data loss, the computational function block might be deemed not to be ready for updating, if this is not the case, the computational function block may be deemed ready to be updated.

Alternatively, the second approach introduced in connection with FIG. 1a to 1c may be used, albeit in a distributed manner, as each computational function block determines its preparedness for update based on its computational function block-specific ruleset. In other words, the processing functionality may be configured to determine the preparedness for update based on a ruleset for determining the preparedness of computational function blocks depending on a state of the computational function block and on a state of the vehicle. For example, the ruleset may be implemented similar to the ruleset introduced in connection with FIGS. 1a to 1c, with the ruleset being computational function block-specific and being included in the computational function block. Depending on the combination of states of the vehicle and the computational function block, the computational function block may be deemed to be ready to be updated, as shown in connection with FIGS. 1a to 1c. For this purpose, the processing functionality may be configured to determine the state of the computational function block and to obtain information on the state of the vehicle from the vehicle (e.g., via car signals 310, as shown in FIG. 3).

As outlined above, the computational function block 20 may be implemented as a software container being executed within a runtime environment 28 of a computation device. Accordingly, the at least one interface 22 may be a software interface for exchanging information, e.g., for receiving and/or transmitting information, which may be in digital (bit) values according to a specified code, within a module, between modules or between modules of different entities. For example, the at least one interface 22 may comprise software functionality being configured to receive and/or transmit information.

Likewise, the processing functionality may be implemented in software, to be executed by the computation device 26, e.g., via the runtime environment 28 of the computation device 26.

Accordingly, the computation device may comprise one or more processors that are configured to execute the computational function block, e.g., by providing the runtime environment 28 for the computational function block. The computation device may further comprise at least one interface for communicating with the apparatus 10. For example, the communication between the computational function block 20 and the apparatus 10 may be conducted via the interface of the computation device. The computation device may further comprise one or more storage devices for storing and/or retrieving information. For example, the one or more processors of the computation device may be coupled with the at least one interface and the one or more storage devices of the computation device. For example, the at least one interface, the one or more processors and/or the one or more storage devices of the computation device may be implemented similar to the at least one interface 12, the one or more processors 14 and/or the one or more storage devices 16 of the apparatus 10. In some examples, the computation device 26 may correspond to the apparatus 10. In this case, the functionality of the apparatus 10 may be provided by the computation device 26.

More details and aspects of the computational function block and the corresponding method and computer program are mentioned in connection with the proposed concept or one or more examples described above or below (e.g., FIG. 1a to 1c, 3). The computational function block and the corresponding method and computer program may comprise one or more additional optional features corresponding to one or more aspects of the proposed concept or one or more examples described above or below.

In the following, the different approaches introduced in connection with FIGS. 1a to 2b are illustrated in an overview drawing. FIG. 3 shows a schematic diagram of three different approaches for updating a computational function block. FIG. 3 shows two components 10a; 10b of the apparatus 10 introduced in connection with FIGS. 1a and 1b, a first component 10a which implements an option A (“dynamic ready for update controller,” the second approach introduced in connection with FIGS. 1a to 1c), and a second component 10b (“container update”), which implements an option B (the first approach in connection with FIGS. 1a to 1c), and which also implements the “generic ready for update” functionality being used in other systems. FIG. 3 further shows a function container (computational function block) 20, with a function-specific update controller, as introduced in connection with FIGS. 2a and/or 2b, to implement option B. FIG. 3 further shows a car signals block 310, which provides car signals to the two components 10a; 10b and to the function container 20, and a backend block 300, which may host the software repository, and which may provide the ruleset for component 10a. The container update block 10b receives the ready-for-update flag either from the component 10a or from the function-specific update controller of the function container 20. The container update triggers the update process of the function container 20.

As previously outlined, the present disclosure provides two options: In option A, a dynamic container, e.g., the apparatus 10 of FIGS. 1a and/or 1b, is implemented with a complex rule set for per-function updates. This function container may obtain an updated set of rules for function updates from the backend—and therefore can always provide a suitable or optimal up-to-date update strategy for each function container. However, this approach may require a special function container, which may be aligned with other function containers in the car.

In option B, the function container itself provides an evaluation on whether it is ready for update. This can be done by two mechanisms. In a first mechanism, the function container may be asked to update. It may wind down all functions and, if ready for updating, sends a “ready for update” flag back to the container updater. Alternatively, the function container may always provide a status flag that is used to report, whether the container is ready for updating. For example, this may be practical if the container reports a negative flag only in a very limited timeframe (e.g., while writing data to flash storage).

In addition to option A and B, the update container software may be configured to overrule the ready for updated flag at any time—if, for example, the function container crashes and never reports a positive update flag, the container update can overrule the negative flag.

In conclusion, the proposed concept may enable container updates based on a Ready-Flag by the (Option A) Update-Ready-Container or by the Container itself (Option B). A dynamic update is provided that is based on the readiness of the container, not based on a general condition (e.g., car inactive). The readiness of the respective containers for update is evaluated.

The container update can also update the container without taking the update flag into account. In this case, the update process may possibly interrupt the container during operation—which may result in data losses or unwanted service drops.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An apparatus for controlling an update process of a computational function block in a vehicle, the apparatus comprising:
at least one interface that, in operation, communicates with the computational function block; and
one or more processors that, in operation,
determine information on a preparedness of the computational function block for updating the computational function block, wherein the information on the preparedness indicates the preparedness of the computational function block; and
trigger an update of the computational function block if the information on the preparedness indicates that the computational function block is ready to be updated.

2. The apparatus according to claim 1, wherein the one or more processors, in operation, obtain, from the computational function block, the information on the preparedness of the computational function block for updating the computational function block.

3. The apparatus according to claim 2, wherein the apparatus, in operation, controls the update process of a plurality of computational function blocks of the vehicle, wherein the one or more processors, in operation, determine information on a preparedness of the plurality of computational function blocks for updating the plurality of computational function blocks by obtaining the information on the preparedness of the plurality of computational function block individually from each of the plurality of computational function blocks, and trigger an update of each of the computational function blocks if the information on the preparedness indicates that each of the computational function blocks is ready to be updated.

4. The apparatus according to claim 3, wherein the computational function block or the plurality of computational function blocks signal their preparedness for updating.

5. The apparatus according to claim 4, wherein the one or more processors, in operation, read out a flag comprising the information on the preparedness from the computational function block or from each of the computational function blocks.

6. The apparatus according to claim 4, wherein the one or more processors, in operation, request the information on the preparedness from the computational function block or from each of the computational function blocks, and receive the information on the preparedness from the computational function block or from each of the computational function blocks in response to the request.

7. The apparatus according to claim 1, wherein the one or more processors, in operation, determine the information on the preparedness based on a ruleset for determining a preparedness of a plurality of computational function blocks depending based on a state of the computational function block and on a state of the vehicle, wherein the ruleset includes rules for determining the preparedness of the computational function blocks for updating on a per-computational function block basis.

8. The apparatus according to claim 7, wherein the computational function block originates from a software repository, wherein the one or more processors, in operation, obtain the ruleset for determining the preparedness of the computational function blocks from the software repository,
and/or wherein the apparatus, in operation, controls the update process of the plurality of computational function blocks of the vehicle, wherein the one or more processors, in operation, determine information on the preparedness of the plurality of computational function blocks for updating the plurality of computational function blocks by determining the preparedness of each of the computational function blocks using the ruleset, and trigger the update of each of the computational function blocks if the information on the preparedness indicates that each of the computational function blocks is ready to be updated.

9. The apparatus according to claim 1, wherein the one or more processors, in operation, override the information on the preparedness of the computation function block if the computation function block is deemed to be unresponsive.

10. A computational function block for a vehicle, the computational function block comprising:
at least one interface that, in operation, with an apparatus that controls an update process of a computational function block; and
a processing functionality configured to:
determine a preparedness of the computational function block for updating the computational function block; and
provide information on the preparedness of the computational function block for updating to the apparatus that controls the update process.

11. The computational function block according to claim 10, wherein the processing functionality, in operation, indicates the information on the preparedness as a flag to the apparatus that controls the update.

12. The computational function block according to claim 10, wherein the processing functionality, in operation, obtains a request for the information on the preparedness from the apparatus that controls the update process, and provides the information on the preparedness to the apparatus that controls the update process in response to the request.

13. A method for controlling an update process of a computational function block in a vehicle, the method comprising:
determining information on a preparedness of the computational function block for updating the computational function block, wherein the information on the preparedness indicates the preparedness of the computational function block; and
triggering an update of the computational function block if the information on the preparedness indicates that the computational function block is ready to be updated.

14. A method for a computational function block for a vehicle, the computational function block performing the method, the method comprising:
determining a preparedness of the computational function block for updating the computational function block; and
providing information on the preparedness of the computational function block for updating.

15. A non-transitory computer-readable medium storing a computer program that when executed by a processor, causes a computer to perform the method of claim 13.
